(19) United States
(12) Patent Application Publication
(10) Pub. No.: US 2020/0226226 A1
(43) Pub. Date: Jul. 16, 2020

(54) Autonomous Vehicle Service Simulation

(71) Applicant: UATC, LLC, San Francisco, CA (US)

(72) Inventors: Vladimir Zaytsev, San Francisco, CA (US); Konrad Julian Niemiec, Mountain View, CA (US)

(21) Appl. No.: 16/595,929

(22) Filed: Oct. 8, 2019

Related U.S. Application Data
(60) Provisional application No. 62/790,818, filed on Jan. 10, 2019.

(51) Int. Cl. G06F 17/50; G06F 11/36

(52) U.S. Cl. CPC G06F 17/5009; G06F 11/362; G06F 17/5095

(57) ABSTRACT

Systems and methods for autonomous vehicle testing are provided. In one example embodiment, a computer-implemented method includes receiving, by a computing system comprising one or more computing devices from a remote computing system, a request for an autonomous vehicle service simulation. The method includes obtaining, by the computing system, data indicative of at least one instance of a simulated autonomous vehicle and data indicative of one or more parameters for simulating an autonomous vehicle service using the at least one instance of the simulated autonomous vehicle. The method includes initiating, by the computing system, an autonomous vehicle service simulation using the at least one instance of the simulated autonomous vehicle and the one or more parameters. The method includes generating, by the computing system, data indicative of the autonomous vehicle service simulation using the at least one instance of the simulated autonomous vehicle and the one or more parameters.

### RELATED APPLICATION

This application claims priority to and the benefit of U.S. Provisional Patent Application No. 62/790,818, titled “Autonomous Vehicle Service Simulation,” and filed on Jan. 10, 2019. U.S. Provisional Patent Application No. 62/790,818 is hereby incorporated by reference herein in its entirety.

### FIELD

The present disclosure relates generally to evaluating computing systems associated with autonomous vehicle services.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path for navigating through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for testing autonomous vehicle services. The method includes receiving, by a computing system comprising one or more computing devices from a remote computing system, a request for an autonomous vehicle service simulation. The method includes obtaining, by the computing system, data indicative of at least one instance of a simulated autonomous vehicle. The method includes obtaining, by the computing system, data indicative of one or more parameters for simulating an autonomous vehicle service using the at least one instance of the simulated autonomous vehicle. The method includes initiating, by the computing system, an autonomous vehicle service simulation using the at least one instance of the simulated autonomous vehicle and the one or more parameters. The method includes generating, by the computing system, data indicative of the autonomous vehicle service simulation using the at least one instance of the simulated autonomous vehicle and the one or more parameters.

Another example aspect of the present disclosure is directed to a computing system. The computing system includes one or more processors, and one or more tangible, non-transitory, computer readable media that collectively store instructions that when executed by the one or more processors cause the computing system to perform operations. The operations include receiving from a remote computing system a request for an autonomous vehicle service simulation, obtaining data indicative of at least one instance of a simulated autonomous vehicle, obtaining data indicative of one or more parameters for simulating an autonomous vehicle service using the at least one instance of the simulated autonomous vehicle, initiating the autonomous vehicle service simulation using the at least one instance of the simulated autonomous vehicle and the one or more parameters, and generating data indicative of the autonomous vehicle service simulation using the at least one instance of the simulated autonomous vehicle and the one or more parameters.

Yet another example aspect of the present disclosure is directed to one or more tangible, non-transitory, computer-readable media that collectively store instructions that, when executed by one or more processors, cause the one or more processors to perform operations. The operations include receiving from a remote computing system a request for an autonomous vehicle service simulation, obtaining data indicative of at least one instance of a simulated autonomous vehicle, obtaining data indicative of one or more parameters for simulating an autonomous vehicle service using the at least one instance of the simulated autonomous vehicle, initiating the autonomous vehicle service simulation using the at least one instance of the simulated autonomous vehicle and the one or more parameters, and generating data indicative of the autonomous vehicle service simulation using the at least one instance of the simulated autonomous vehicle and the one or more parameters.

Other example aspects of the present disclosure are directed to systems, methods, vehicles, apparatuses, tangible, non-transitory computer-readable media, and memory devices for testing autonomous vehicle services.

These and other features, aspects and advantages of various embodiments will become better understood with reference to the following description and appended claims.

The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing environment including an autonomous vehicle computing system according to example embodiments of the present disclosure;

FIG. 2 depicts an example computing system including a vehicle service testing system according to example embodiments of the present disclosure;

FIG. 3 depicts an example computing system including an autonomous vehicle service platform having a platform vehicle simulation service according to example embodiments of the present disclosure;

FIG. 4 depicts an example computing system including an autonomous vehicle service platform and a local vehicle simulation service according to example embodiments of the present disclosure;

FIG. 5 depicts a flowchart illustrating an example method for performing an autonomous vehicle service simulation according to example embodiments of the present disclosure;

FIG. 6 depicts an example of vehicle routes associated with autonomous vehicles in a geographic area according to example embodiments of the present disclosure;

FIG. 7 depicts an example computing system including a simulated autonomous vehicle instance according to example embodiments of the present disclosure;

FIG. 8 depicts an example computing system including a vehicle simulation process according to example embodiments of the present disclosure;

FIG. 9 depicts a flowchart illustrating an example method for initializing and performing an autonomous vehicle simulation according to example embodiments of the present disclosure;

FIG. 10 depicts example system units for performing operations and functions according to example embodiments of the present disclosure; and

FIG. 11 depicts an example computing system according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved techniques for testing autonomous vehicle services through computer-implemented simulations of vehicle service-flows that utilize autonomous vehicles. A vehicle service test system provides one or more interfaces that enable users (e.g., software developers for autonomous vehicle computing systems) to design and test vehicle services using simulated autonomous vehicles. Data defining a simulated autonomous vehicle can be obtained in response to input received from a user through the one or more user interfaces. Similarly, data indicative of one or more parameters for at least one vehicle service simulation can be obtained, for example, in response to input received from a user through the one or more user interfaces. The test system may obtain from a remote computing system a request for an autonomous vehicle simulation. The test system can initiate one or more vehicle service simulations using the one or more parameters and the simulated autonomous vehicle. In this manner, users can define and debug vehicle service-flows within a single set of user interfaces. A user can manually control a vehicle service-flow in some examples by controlling an autonomous vehicle state. In other examples, a user can automate control of the vehicle service-flow using one or more predefined simulation scenarios. By providing a simulated testing environment that provides developer control over vehicle service-flows as well as autonomous vehicle definition, a quick and efficient technique for designing and evaluating vehicle service-flows can be provided. Such a technique may avoid computational waste that may be incurred by systems that attempt to test vehicle service-flows and/or autonomous vehicles outside of a simulated environment. In such systems, small changes to a vehicle service flow and/or an autonomous vehicle may require significant changes to test systems. By contrast, the disclosed technology enables vehicle services and autonomous vehicle designs to be quickly and efficiently tested.

An autonomous vehicle can be a vehicle that can drive, navigate, operate, etc. with little to no human input. To do so, the autonomous vehicle can include an autonomous vehicle computing system containing an autonomy software stack. The autonomy software stack can enable the autonomous vehicle to perceive object(s) within its surrounding environment, predict the motion of those objects, and plan the motion of the autonomous vehicle, accordingly. In some instances, an autonomous vehicle may be used to provide an autonomous vehicle service for one or more service entities. For example, a service entity can be an individual, a group of individuals, a company (e.g., a business entity, organization, etc.), a group of entities (e.g., affiliated companies), and/or another type of entity that offers and/or coordinates the provision of vehicle service(s) to one or more users. For example, a service entity can offer vehicle service(s) to users via a software application (e.g., on a user computing device, etc.), via a website, and/or via other types of interfaces that allow a user to request a vehicle service. The vehicle services can include user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services.

Example aspects of the present disclosure provide improved systems and methods for testing vehicle services that utilize autonomous vehicles. More particularly, a vehicle service test system in accordance with the disclosed technology can provide for improved evaluation of autonomous vehicle services using simulated autonomous vehicles. The test system can enable simulation of an autonomous vehicle as part of a vehicle service within a simulation environment including a geographic area. Various systems and devices configured to control the operation of the vehicle can be simulated. For example, an autonomous vehicle can include an onboard vehicle computing system (e.g., located on or within the autonomous vehicle) that is configured to operate the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the vehicle to communicate with a computing system that is remote from the vehicle such as, for example, that of a service entity.

A simulated autonomous vehicle may include a simulation of any portion or all of an autonomous vehicle. For example, an autonomy software stack of an autonomous vehicle or other computer-based systems of the autonomous vehicle can be simulated. One or more instances of a simulated autonomous vehicle can be provisioned and deployed at one or more computing devices. Data including one or more parameters associated with a vehicle service simulation can be obtained. A software developer can provide control commands and/or predefined simulation scenarios for the instance of the autonomous vehicle. Each of the one or more predefined simulation scenarios can be provided as a respective scenario object to the at least one instance of the simulated autonomous vehicle in example embodiments. One or more vehicle service simulations can be performed using the instance of the simulated autonomous vehicle and the one or more parameters. Data indicative of the vehicle service simulations can be generated and/or stored by the vehicle service testing system. In this manner, a vehicle service-flow and/or autonomous vehicle can be quickly evaluated and debugged prior to actual deployment of an autonomous vehicle in association with the vehicle service.

The vehicle service test system can obtain data defining at least one instance of a simulated autonomous vehicle. In some examples, a user such as a developer may define the at least one instance of the simulated autonomous vehicle using one or more interfaces provided by the vehicle service test system. In this manner, a user may provision a new simulated autonomous vehicle to be evaluated in accordance with one or more vehicle services. The data defining the at least one instance of the simulated autonomous vehicle may include data defining one or more capabilities of the autonomous vehicle, a state of the autonomous vehicle, etc.

The instance(s) of the simulated autonomous vehicle can be deployed as a network service in some examples, such as at one or more servers in direct communication with the vehicle service test system. In other examples, the instances of the simulated autonomous vehicle can be deployed at a computing device remote from the vehicle service test system. The remote computing device can be operated by the same entity that operates an autonomous vehicle service platform, or by a third-party entity. In either case, the vehicle service test system can communicate with the simulated autonomous vehicle instances using various communication protocols. In some examples, each instance of a simulated autonomous vehicle may include an interface such as an interface programmed in a software development kit (SDK) that is similar to or the same as an interface (e.g., SDK) included within an actual autonomous vehicle used to provide the vehicle service. The interface may enable the vehicle test system to issue instructions to the autonomous vehicle instance to accept a service request, reject a service request, update the pose field of the autonomous vehicle instance, etc.

The vehicle service test system can obtain data indicative of one or more parameters for at least one vehicle service simulation. The parameters for a vehicle service simulation may include parameters that define a vehicle service-flow. For example, data defining a vehicle service-flow may define a dispatch of a vehicle service to an instance of a simulated autonomous vehicle. Data defining the vehicle service-flow may also include data instructing the instance of the simulated autonomous vehicle to accept or reject the service request. The data may additionally include data indicative of service-flow updates and/or location updates. The data may indicate a route from a pick-up location to a drop-off location in example embodiments.

The vehicle test system can obtain data for controlling a state of the instance of the simulated autonomous vehicle. The data for controlling the state of the simulated autonomous vehicle instance may enable a user to define or control the autonomous vehicle state. The autonomous vehicle state may be controlled directly, such as by issuing commands to the instance of the autonomous vehicle, or may be controlled using one or more predefined simulation scenarios. In various examples, data indicative of a vehicle state may indicate a position of the simulated autonomous vehicle, credentials for the autonomous vehicle, an autonomous vehicle status, or a client at the vehicle service test system that is associated with the instance of the simulated autonomous vehicle.

The vehicle test system can perform one or more autonomous vehicle (AV) service simulations using an instance of the simulated autonomous vehicle. An AV service simulation can include parameters that define a step (also referred to as a tick) duration, a vehicle movement strategy (e.g., no operation, move to pickup and drop-off locations, move using a constant speed and straight line, or move using a constant number of steps), vehicle callbacks (e.g., always reject, always accept, no operation), and/or a maximum number of steps. A vehicle service simulation can result in a termination condition in response to a vehicle entering a terminal state (e.g., vehicle is offline), a vehicle performing a terminating transition (e.g., door open), a termination command being executed, or a maximum number of steps being reached.

In accordance with some aspects of the disclosed technology, the test system may determine and store metrics for a simulated autonomous vehicle session. Example metrics may include for interface calls (e.g., programmed in an SDK): a number of succeeded method attempts; a number of failed method attempts; a latency of attempts; and a number of bytes in and out. Example metrics for the session may further include a vehicle state heartbeat; a state using a I/O gauge; an exceptions or equivalent (e.g., exception tag); all exceptions; and vehicle uptime.

In accordance with some aspects of the disclosed technology, the test system may determine and store metrics for a simulated autonomous vehicle service. Example metrics may include: CPU; memory; GC; number of containers; number of threads; uptime; and a number of sessions. Metrics for interface calls (e.g., remote procedure calls) may include: a number of succeeded method attempts; a number of failed method attempts; a latency of attempts; and a number of bytes in and out.

In some examples, the test system may determine and store success metrics including, by way of example: a time to set up a simulated AV instance and dispatch a trip from the service-flow simulator; a time to provision a simulated AV instance locally or in the platform (e.g., cloud-based) and to go online; a number active platform simulated AVs and sessions per week; a number of platform test services per week; a number of finished scenario jobs per week; a number of scenarios; and a number of other projects using the simulated AV instances.

According to some example aspects, a vehicle service test system is provided for an autonomous vehicle service platform. The autonomous vehicle service platform includes a service-flow simulator configured as a tool for simulating service-flows using an autonomous vehicle. The vehicle service test system can include one or more vehicle simulation services. A vehicle simulation service can include one or more instances of a simulated autonomous vehicle. A vehicle simulation service can be provided at the autonomous vehicle service platform as a platform vehicle simulation service in some examples. Additionally and/or alternatively, a vehicle simulation service can be implemented at a computing device remote from the autonomous vehicle service platform as a local vehicle simulation service for example.

In some implementations, an autonomous vehicle service platform can include an integration platform configured to integrate autonomous vehicles (e.g., autonomous computing systems) with the autonomous vehicle service platform. In some examples, the integration platform is configured to integrate autonomous vehicles from different systems, such as from different vendors or providers of autonomous vehicles. The integration platform enables multiple third-party systems to be integrated into a single autonomous vehicle service platform. Additionally, the integration platform enables autonomous vehicles directly controlled by the operator of the autonomous vehicle service platform to be integrated into a common service with autonomous vehicles from third-party systems.

A real-time interface can be provided between the integration platform and the service-flow simulator. A service request can be provided from the service-flow simulator through the real-time interface to the integration platform. The autonomous vehicle service platform can include a service-flow updater that passes service-flow updates to and from the integration platform. Service-flow updates can be received at the integration platform as a push notification from the updater. An update can be passed to the instance of the simulated autonomous vehicle corresponding to the service request. For example, an interface (e.g., SDK) inside the autonomous vehicle instance can establish a consistent connection (e.g., HTTP2) with the integration platform. A service request can be matched with the instance of the autonomous vehicle using a flag or other suitable identifier.

The instance of the autonomous vehicle connected to the integration platform can be controlled in various manners to facilitate simulation of an autonomous vehicle. For example, a developer can control an instance of the autonomous vehicle directly using commands (e.g., control line interface commands or browser-based interface commands) in some examples. In other examples, a developer can run a predefined simulation scenario to simulate an autonomous vehicle service using the instance of the autonomous vehicle.

In some examples, a vehicle simulation service can be implemented remotely from the autonomous vehicle service platform as a local vehicle simulation service. A developer can dispatch a vehicle service to a locally running instance of a simulated autonomous vehicle. For example, the developer can utilize an interface to the service-flow simulator to initiate a vehicle service request. The developer can also start the local vehicle simulation service using an interface such as a command line interface (CLI) tool. In some examples, a self-signed autonomous vehicle certificate and credentials obtained from an accounts tool can be used. The interface inside the local vehicle simulation service can establish a consistent connection with the integration platform and perform authentication. After the local vehicle simulation service is connected to the integration platform, a developer can access the service-flow simulator through an interface using the same test credentials to make a vehicle service request. In some examples, this can be done using a real-time application programming interface (API) client. The vehicle service request can be matched with the instance of the simulated autonomous vehicle using a tag or other identifier. The integration platform can receive a push notification from the service flow updater and forward it to the interface of the autonomous vehicle instance running inside the local vehicle simulation service. The developer can control the autonomous vehicle instance using commands or by running a predefined simulation scenario to simulate a vehicle service. In some examples, the local vehicle simulation service can be configured to save logs in a file and/or send them to a remote service.

In some examples, a vehicle simulation service can be implemented at the autonomous vehicle service platform, such as at the same set of servers and/or within the same network used to implement the autonomous vehicle service. Such a platform vehicle simulation service can include one or more instances of a simulated autonomous vehicle. Each instance of the simulated autonomous vehicle can include an interface (e.g., SDK) associated with the integration platform. A developer can provide data in association with the instance of the autonomous vehicle and data in association with the vehicle service simulation through the same interface. For example, a developer can access an interface for the simulator to initialize and/or modify a state of the simulated autonomous vehicle instance. Additionally, the same interface may be used to dispatch, accept, and simulate a vehicle service using the autonomous vehicle instance. In this manner, a developer can use a graphical user interface such as a browser interface rather than a command line interface for controlling an autonomous vehicle instance. The simulator may include a vehicle simulation service client configured to communicate with the platform vehicle simulation service. For example, the vehicle simulation service client can communicate with the platform vehicle simulation service to accept vehicle service requests and control the autonomous vehicle instance. The state of the autonomous vehicle instance can be stored and updated in the simulator interface, and pushed to the platform vehicle simulation service. The platform vehicle simulation service can be stateful and can route calls to the autonomous vehicle instance where the requested autonomous vehicle interface is running.

In accordance with example aspects, a vehicle simulation service may include a session which is a stable, long-running task used to simulate a vehicle service-flow of an autonomous vehicle. In such examples, one instance of the vehicle simulation service session can be used to model one instance of the autonomous vehicle. For example, there can be one instance of the same simulated autonomous vehicle session within the autonomous vehicle service platform at a given time. In this manner, two sessions of an autonomous vehicle instance can be the same if they start using the same simulated autonomous vehicle identifier.

A simulated autonomous vehicle instance can include a session simulator and an integration platform interface in some examples. The integration platform interface can be a software development kit in some embodiments. The session simulator can include a state component and a controller. The state of a simulated autonomous vehicle instance session can be compact and simple. For example, the state of an AV instance session can include attributes such as a position of the autonomous vehicle, credentials for the autonomous vehicle, a status of the autonomous vehicle, and/or an identification of the vehicle simulation service client interface at the service-flow simulator. In some examples, the state can be persisted in an external and/or internal system. This may allow restoring sessions after service upgrades and restarts. The session controller can be used to access and modify the session state. The session simulator can provide callbacks to the integration platform interface and can define behavior of the simulated autonomous vehicle by connecting the integration platform interface with the session state. For example, the session simulator can define callbacks giving vehicle position from the session state to the integration platform interface. The session simulator can also be used to execute simulation scenarios. Locally, a developer can link a vehicle simulation service to a custom location of an integration platform interface repository for debugging. With the vehicle simulation services implemented at the platform, a mechanism and remote procedure call can be exposed for setting a custom version of the integration platform interface for each session individually to provide improved flexibility.

In some examples, a vehicle simulation service process may communicate with the integration platform and simulation interfaces such as the service-flow simulator interface and/or vehicle simulator interface. In some examples, interfaces may be provided at one or more client computing devices. The vehicle simulation service process may include one or more endpoints (e.g., remote procedure call (RPC) end points) to facilitate communication with simulation interfaces (e.g., client computing devices using CLI and/or RPC). For example, the vehicle simulation service process can route remote procedure calls to simulated autonomous vehicle session controllers using client RPC credentials. Optionally, the vehicle simulation service process can include an interface tool which can simplify calling RPC endpoints from a terminal. The one or more endpoints may receive and/or transmit credentials, simulation scenarios, and/or control commands to and from the simulation interfaces. The vehicle simulation service process may additionally include an integration component and configuration injector. The vehicle simulation service process may include one or more vehicle sessions. The vehicle simulation service process may receive one or more default credentials and/or default simulation scenarios from a configuration/environment. The vehicle simulation service process may send and receive service-flow updates to and from the integration platform. Additionally, the vehicle simulation service process may provide location updates of the simulated autonomous vehicle to the integration platform. Various logs and metrics associated with a vehicle simulation can be provided from the vehicle simulation service process to a logging/metrics interface. Optionally, the vehicle simulation service process can provide data indicative of a simulated autonomous vehicle session state and/or synchronization information to a storage device or service. In some examples, a vehicle simulation service can optionally allow the use of an external storage service for persisting and restoring vehicle sessions. The external storage can also be used to implement synchronization for simulated autonomous vehicle sessions such as in a sharding mechanism.

In accordance with example embodiments, a simulated autonomous vehicle instance may utilize one or more application programming interfaces (APIs). For example, a first call may allow provisioning of an autonomous vehicle. The first call may cause the generation of a self-signed certificate and the creation of a new instance of an autonomous vehicle. An error may be returned if there is already an existing instance of the vehicle created with the same universal identifier. A second call may cause deletion of a vehicle instance from the vehicle simulation service. An error can be returned of the vehicle does not exist or cannot be removed. A third call can cause retrieval of information about a given vehicle instance. A fourth call can return information about all vehicle instances provisioned within the vehicle simulation service.

In accordance with example embodiments, a session simulator of a simulated autonomous vehicle instance may utilize one or more APIs. A first call for the session simulator may start a new simulated autonomous vehicle session for a given vehicle. A second call can stop a simulated autonomous vehicle session for a given vehicle. A third call can return the current state of an autonomous vehicle session. A fourth call can attempt to execute a go online function and update the status field of a vehicle state. A fifth call can attempt to execute a client go off-line function and update a status field of the vehicle state. A sixth call can update the pose field of the vehicle state. A seventh call can instruct the session simulator to accept a vehicle service request. An eighth call can instruct the session simulator to reject a vehicle service request. A ninth call can find a stored simulation scenario by universal identifier and execute it. A tenth call can execute a provided simulation scenario object.

The systems and methods described herein provide a number of technical effects and benefits. More particularly, the systems and methods of the present disclosure provide improved techniques for testing vehicle services using autonomous vehicles. For instance, a computing system can evaluate one or more vehicle services by simulating a vehicle service-flow using an instance of a simulated autonomous vehicle. A vehicle service simulation can be based on one or more parameters provided by a user such as a software developer. The one or more parameters may relate to the autonomous vehicle instance and/or the vehicle service-flow. In this manner, the computing system may quickly and efficiently evaluate different vehicle services for different autonomous vehicles having different capabilities or attributes. Such a technique can provide a technical improvement with respect to traditional processes for evaluating autonomous vehicles relative to autonomous vehicle services. For example, a simulated vehicle service-flow can be analyzed using a simulated autonomous vehicle to avoid wasteful usage of computational resources that may be incurred where simulations are not employed.

In accordance with some embodiments, a developer can provide control commands to simulate autonomous vehicle operations in association with the vehicle service. The control commands can allow developer to initialize and/or manipulate an autonomous vehicle state to evaluate the response of the simulated autonomous vehicle while performing a vehicle service. In this manner, the response characteristics of different autonomous vehicles can be evaluated with respect to different types of vehicle services to better understand and evaluate the resulting performance. In this manner, simulations can be implemented to test and evaluate each aspect of a vehicle service with respect to a particular autonomous vehicle type. Such a technique can allow successful integration of multiple third-party systems, such as various vendors of autonomous vehicles, within a single autonomous vehicle service platform. In this manner, a service entity can utilize autonomous vehicles from multiple vendors in a single system in both a resource and time-efficient manner while avoiding computational waste associated with some computing processes. For example, vehicle services provided by the vehicle service platform can be evaluated to demonstrate the performance of various autonomous vehicles while performing different vehicle services.

In accordance with some examples, a developer can provide parameters to simulate various types of vehicle service-flows with respect to an autonomous vehicle. A developer can manually control a vehicle service using control commands in some examples. In other examples, predefined simulation scenarios can be used with respect to autonomous vehicles. Such a technique can allow a developer to evaluate numerous vehicle services to determine the resulting performance of different types of autonomous vehicles with respect to the vehicle services. Moreover, a developer can debug a vehicle service flow to identify any issues that may be associated with deployment of the vehicle.

Various means can be configured to perform the methods and processes described herein. For example, a computing system can include data obtaining unit(s), vehicle service simulation unit(s), data generation unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain data indicative of at least one instance of a simulated autonomous vehicle and/or data indicative of one or more parameters for at least one vehicle service simulation. (e.g., via an accessible memory). In some implementations, the means can be configured to obtain data indicative of an instance of an autonomous vehicle by obtaining data that defines the at least one instance of the simulated autonomous vehicle. In some implementations, the means can be configured to obtain from through a user interface data that is utilized to provision at least one instance of a simulated autonomous vehicle. In some implementations, the means can be configured to obtain data indicative of order more predefined simulation scenarios. In some implementations, the means can be configured to obtain data indicative of one or more control commands for controlling an instance of an autonomous vehicle. In some implementations, the means can be configured to receive data indicative of at least one state associated with the simulated autonomous vehicle. A data obtaining unit is one example of a means for obtaining such data as described herein.

The means can be configured to initiate at least one vehicle service simulation using at least one instance of a simulated autonomous vehicle and one or more parameters for the vehicle service simulation. For example, the means can be configured to transmit to the at least one instance of the simulated autonomous vehicle of vehicle service update based at least in part of the more parameters. The means can be configured to receive from the at least one instance of the simulated autonomous vehicle or more location updates based at least in part of vehicle service update. In some examples, the means can be configured to implement vehicle simulation session have a state. The state can include one or more attributes. The attributes can include a position of the simulated autonomous vehicle, a status of the simulated autonomous vehicle, credentials associated with of the simulated autonomous vehicle, and/or other information. A vehicle service simulation unit is one example of a means for initiating a vehicle service simulation using at least one instance of a simulated autonomous vehicle and one or more parameters for the at least one vehicle service simulation.

The means can be configured to generate data indicative of the at least one autonomous vehicle service simulation. The means can be configured to generate the data based at least in part on the instance of the simulated autonomous vehicle and the one or more parameters obtained by the data obtaining means. The means can be configured to generate simulated autonomous vehicle session state information and/or synchronization information. A data generation unit is one example of a means for generating data indicative of at least one autonomous vehicle service simulation.

With reference to the figures, example embodiments of the present disclosure will be discussed in further detail.

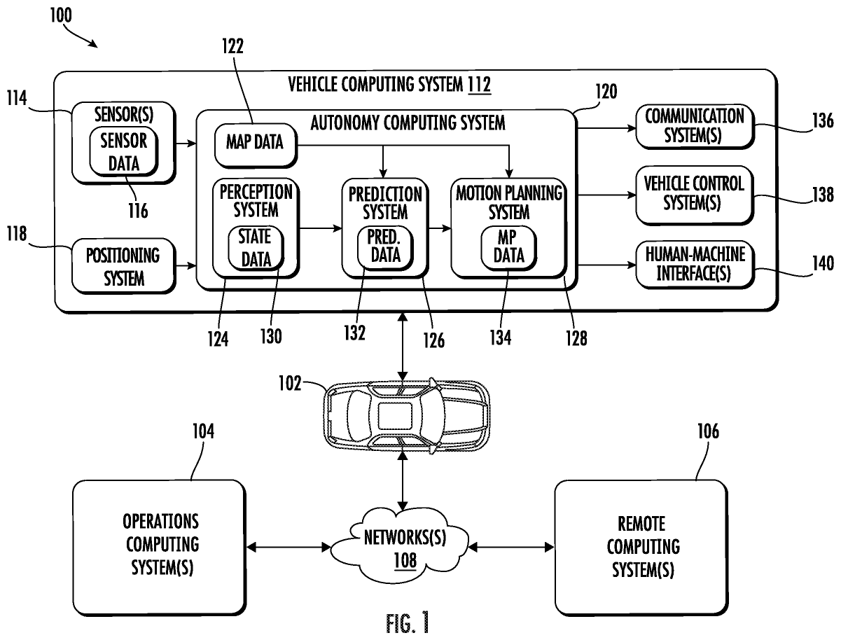

FIG. 1 depicts a block diagram of an example system 100 for controlling the navigation of a vehicle according to example embodiments of the present disclosure. As illustrated, FIG. 1 shows a system 100 that can include a vehicle 102; an operations computing system 104; one or more remote computing systems 106; a communication network 108; a vehicle computing system 112; one or more autonomy system sensors 114; autonomy sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider (e.g., service entity) that can provide one or more vehicle services to a plurality of users via a fleet of vehicles (e.g., service entity vehicles, third-party vehicles, etc.) that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of one or more vehicles (e.g., a fleet of vehicles), with the provision of vehicle services, and/or other operations as discussed herein.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing systems 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing systems 106 can include one or more processors and one or more memory devices. The one or more memory devices can be used to store instructions that when executed by the one or more processors of the one or more remote computing systems 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The one or more remote computing systems 106 can communicate (e.g., exchange data and/or signals) with one or more devices including the operations computing system 104 and the vehicle 102 via the communications network 108.

The one or more remote computing systems 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing systems 106 can be used to determine and/or modify one or more states of the vehicle 102 including a location (e.g., a latitude and longitude), a velocity, acceleration, a trajectory, and/or a path of the vehicle 102 based in part on signals or data exchanged with the vehicle 102. In some implementations, the operations computing system 104 can include the one or more remote computing systems 106.

The vehicle 102 can be a ground-based vehicle (e.g., an automobile, bike, scooter, other light electric vehicle, etc.), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, and/or the state of an environment to the operations computing system 104, which can store an indication, record, and/or other data indicative of the state of the one or more objects within a predefined distance of the vehicle 102 in one or more memory devices associated with the operations computing system 104 (e.g., remote from the vehicle). Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The autonomy sensor data 116 can be indicative of locations associated with the one or more objects within the surrounding environment of the vehicle 102 at one or more times. For example, autonomy sensor data 116 can be indicative of one or more LIDAR point clouds associated with the one or more objects within the surrounding environment. The one or more autonomy system sensors 114 can provide the autonomy sensor data 116 to the autonomy computing system 120.

In addition to the autonomy sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing system 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on autonomy sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around an vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing systems 106) over one or more networks (e.g., via one or more wireless signal connections, etc.). In some implementations, the communications system 136 can allow communication among one or more of the systems on-board the vehicle 102. The communications system 136 can also be configured to enable the autonomous vehicle to communicate with and/or provide and/or receive data and/or signals from a remote computing system 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat).

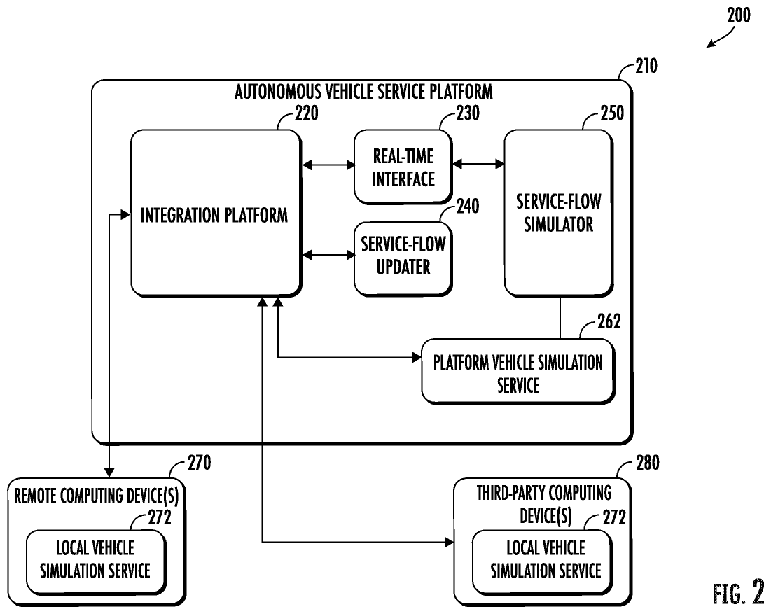

FIG. 2 depicts an example computing system including a vehicle service testing system 200 for an autonomous vehicle service platform 210 according to example embodiments of the present disclosure. Autonomous vehicle service platform 210 includes an integration platform 220, a real-time interface 230, a service-flow updater 240, a service-flow simulator 250, and a platform vehicle simulation service 260. Autonomous vehicle service platform 210 is in communication with one or more remote computing devices 270, such as may be operated by the autonomous vehicle service provider associated with the autonomous vehicle service platform 210. Autonomous vehicle service platform 210 may be in further communication with one or more third-party computing devices 280 operated by one or more third-party entities, such as one or more third-party entities that operate one or more autonomous vehicles in association with the autonomous vehicle service platform 210. Any number of remote computing devices 270 and/or third-party computing devices 280 may be utilized.

In some implementations, an autonomous vehicle service platform 210 can include an integration platform 220 configured to integrate autonomous vehicles (e.g., autonomous computing systems) with the autonomous vehicle service platform. Integration platform 220 can integrate autonomous vehicles from different systems, such as from third-party computing devices 280 from different vendors or providers of autonomous vehicles. Integration platform 220 enables multiple third-party systems to be integrated into a single autonomous vehicle service platform 210. Additionally, integration platform 220 enables autonomous vehicles directly controlled by the operator of the autonomous vehicle service platform to be integrated into a common service with autonomous vehicles from third-party systems.

Autonomous vehicle service platform 210 includes a service-flow simulator 250 configured as a tool for simulating service-flows using an autonomous vehicle. An instance(s) of a simulated autonomous vehicle can be deployed as a network service in some examples, such as at one or more servers in direct communication with the vehicle service test system. In other examples, the instances of the simulated autonomous vehicle can be deployed at a local computing device remote from the vehicle service test system. The local computing device can be operated by the same entity that operates an autonomous vehicle service platform, or by a third-party entity. The vehicle service test system 200 can include one or more platform vehicle simulation services 262 that are part of the autonomous vehicle service platform and/or one more local simulation services 272 that are remote from the AV service platform.

A vehicle simulation service can include one or more instances of a simulated autonomous vehicle. A vehicle simulation service can be provided at the autonomous vehicle service platform as a platform vehicle simulation service 262 in some examples. Additionally and/or alternatively, a vehicle simulation service can be implemented at a computing device remote from the autonomous vehicle service platform as local vehicle simulation service 272. By way of example, one or more local vehicle simulation services 272 can be implemented by one or more remote computing devices 270. Additionally and/or alternatively, one more local vehicle simulation services 272 can be implemented by one or more third-party computing devices 280.

A real-time interface 230 can be provided between the integration platform 220 and the service-flow simulator 250. A service request can be provided from the service-flow simulator 250 through the real-time interface 230 to the integration platform 220. The autonomous vehicle service platform 210 can include a service-flow updater 240 that passes service-flow updates to and from the integration platform 220. Service-flow updates can be received at the integration platform 220 as a push notification from the service-flow updater 240. An update can be passed to an instance of the simulated autonomous vehicle corresponding to a service request. For example, an interface (e.g., SDK) inside the autonomous vehicle instance can establish a consistent connection (e.g., HTTP2) with the integration platform. A service request can be matched with the instance of the autonomous vehicle using a flag or other suitable identifier.

The instance of the autonomous vehicle connected to the integration platform can be controlled in various manners to facilitate simulation of an autonomous vehicle. For example, a developer can control an instance of the autonomous vehicle directly using commands (e.g., control line interface commands or browser-based interface commands) in some examples. In other examples, a developer can run a predefined simulation scenario to simulate an autonomous vehicle service using the instance of the autonomous vehicle.

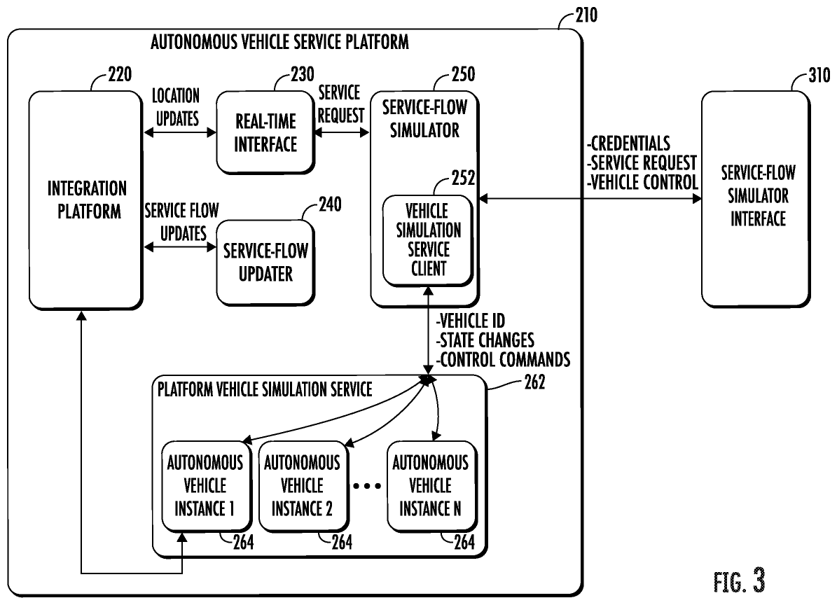

A vehicle simulation service can be implemented at the autonomous vehicle service platform, such as at the same set of servers and/or within the same network used to implement the autonomous vehicle service. FIG. 3 depicts an example computing system including an autonomous vehicle service platform 210 having a platform vehicle simulation service 262 according to example embodiments of the present disclosure.

A platform vehicle simulation service 262 can include one or more instances 264 of a simulated autonomous vehicle. Any number of autonomous vehicle instances 264 may be included within the platform vehicle simulation service. Each instance of the simulated autonomous vehicle can include an interface (e.g., SDK) associated with the integration platform. A developer can provide data in association with the instance of the autonomous vehicle and data in association with the vehicle service simulation through the same interface. For example, a developer can access a service-flow simulator interface 310 to provide credentials, initialize, and/or modify a state of the simulated autonomous vehicle instance. Additionally, the same interface may be used for service requests in order to dispatch, accept, and simulate a vehicle service using the autonomous vehicle instance. Vehicle controls may also be provided through the service-flow simulator interface 310. In this manner, a developer can use a graphical user interface such as a browser interface rather than a command line interface for controlling an autonomous vehicle instance 264.

The service-flow simulator 250 may include a vehicle simulation service client 252 configured to communicate with the platform vehicle simulation service 262. For example, the vehicle simulation service client 252 can communicate with the platform vehicle simulation service 262 to accept vehicle service requests and control the autonomous vehicle instance to 64. The state of the autonomous vehicle instance to 64 can be stored and updated in the service-flow simulator interface 310, and pushed to the platform vehicle simulation service 262. The platform vehicle simulation service 262 can be stateful and can route calls to the autonomous vehicle instance where the requested autonomous vehicle interface is running.

Vehicle service test system 200 can communicate with the simulated autonomous vehicle instances 264 using various communication protocols. In some examples, each instance of a simulated autonomous vehicle may include an interface such as an interface programmed in a software development kit (SDK) that is similar to or the same as an interface (e.g., SDK) included within an actual autonomous vehicle used to provide the vehicle service. The interface may enable the vehicle test system to issue instructions to the autonomous vehicle instance to accept a service request, reject a service request, update the pose field of the autonomous vehicle instance, etc.

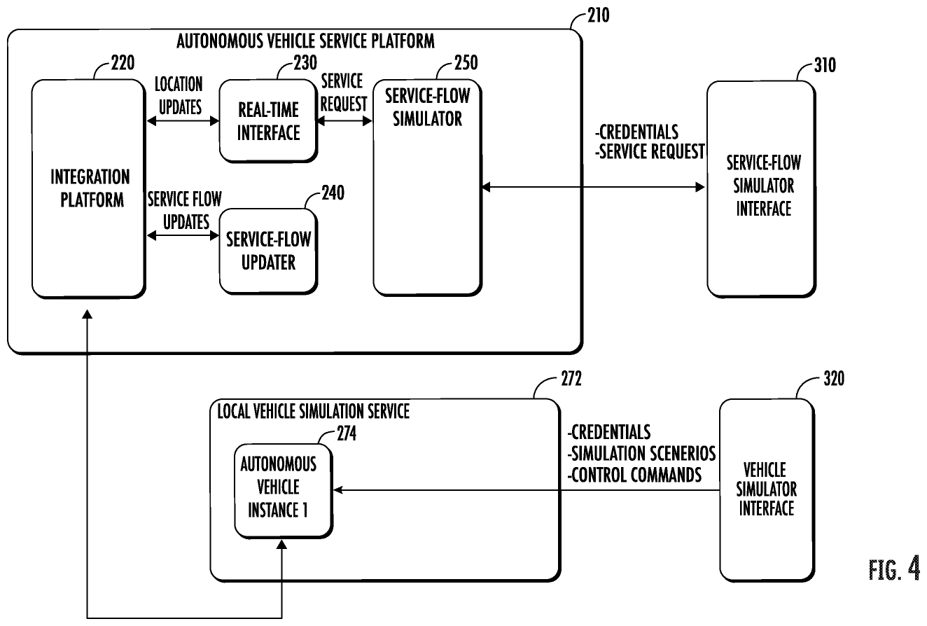

A vehicle simulation service can be implemented remotely from the autonomous vehicle service platform as a local vehicle simulation service in some examples. FIG. 4 depicts an example computing system including an autonomous vehicle service platform 210 and a local vehicle simulation service 272 according to example embodiments of the present disclosure. A local vehicle simulation service 272 may be implemented by one or more remote computing devices operated by the autonomous vehicle service provider, and/or at one or more third-party computing devices. Although a single local vehicle simulation service 272 is depicted, any number of local vehicle simulation services may be included in various embodiments.

A developer can access a vehicle simulator interface 320 to provide credentials, provide simulation scenarios, and/or to provide control commands for an autonomous vehicle instance 274. Any number of autonomous vehicle instances 274 may be included within a local vehicle simulation service 272. A developer can dispatch a vehicle service to a locally running instance 274 of a simulated autonomous vehicle. For example, the developer can utilize service-flow simulator interface 310 to access the service-flow simulator 250 and initiate a vehicle service request. The developer can also start the local vehicle simulation service using vehicle simulator interface 320, such as a command line interface (CLI) tool. In some examples, a self-signed autonomous vehicle certificate and credentials obtained from an accounts tool can be used. The interface inside the local vehicle simulation service to 72 can establish a consistent connection with the integration platform 220 and perform authentication. After the local vehicle simulation service 272 is connected to the integration platform 220, a developer can access the service-flow simulator 250 through service-flow simulator interface 310 using the same test credentials to make a vehicle service request. In some examples, this can be done using a real-time application programming interface (API) client. The vehicle service request can be matched with the instance of the simulated autonomous vehicle using a tag or other identifier. The integration platform 220 can receive a push notification from the service-flow updater 240 and forward it to the interface of the autonomous vehicle instance 274 running inside the local vehicle simulation service 272. The developer can control the autonomous vehicle instance 274 using commands or by running a predefined simulation scenario to simulate a vehicle service. In some examples, the local vehicle simulation service 272 can be configured to save logs in a file and/or send them to a remote service.

Vehicle service test system 200 can communicate with the simulated autonomous vehicle instances 274 using various communication protocols. In some examples, each instance of a simulated autonomous vehicle may include an interface such as an interface programmed in a software development kit (SDK) that is similar to or the same as an interface (e.g., SDK) included within an actual autonomous vehicle used to provide the vehicle service. The interface may enable the vehicle test system to issue instructions to the autonomous vehicle instance to accept a service request, reject a service request, update the pose field of the autonomous vehicle instance, etc.

A simulated autonomous vehicle instance such as a platform AV instance 264 and/or local AV instance to 74 may include a simulation of any portion or all of an autonomous vehicle. For example, an autonomy software stack of an autonomous vehicle or other computer-based systems of the autonomous vehicle can be simulated. One or more instances of a simulated autonomous vehicle can be provisioned and deployed at one or more computing devices.

One or more vehicle service simulations can be performed using the instance of the simulated autonomous vehicle and the one or more parameters. Data indicative of the vehicle service simulations can be generated and/or stored by the vehicle service testing system. In this manner, a vehicle service-flow and/or autonomous vehicle can be quickly evaluated and debugged prior to actual deployment of an autonomous vehicle in association with the vehicle service.

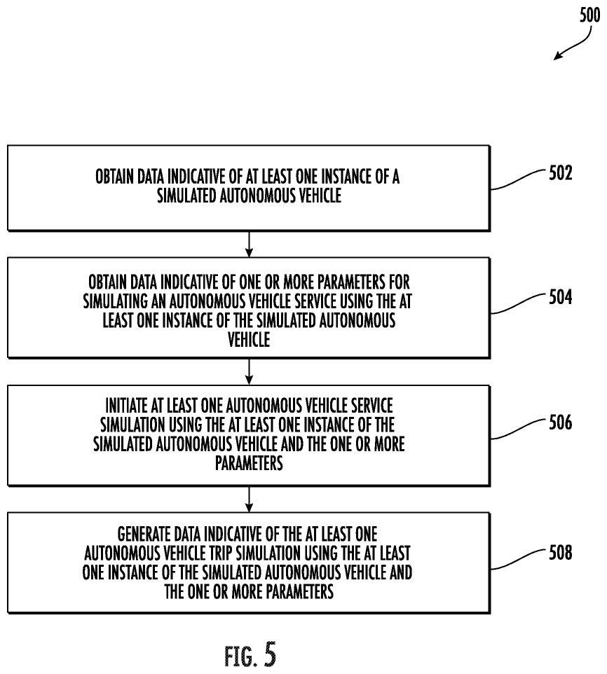

FIG. 5 depicts a flowchart illustrating an example method 500 for performing an autonomous vehicle service simulation according to example embodiments of the present disclosure. One or more portion(s) of the operations of method 500 can be implemented by one or more computing systems that include, for example, a vehicle computing system (e.g., vehicle computing system 112, etc.), an autonomous vehicle service platform 210, one or more portions of an operations computing system (e.g., operations computing system 104, etc.), one or more remote computing systems (e.g., remote computing system 106, remote computing device 270, third-party computing device 280, etc.), computing system 1002, computing system 1102, vehicle service test system 200, and/or one or the like. Each respective portion of the method 500 can be performed by any (or any combination) of the computing device(s) of the respective computing system. Moreover, one or more portion(s) of the method 500 can be implemented as an algorithm on the hardware components of the device(s) described herein (e.g., as in FIGS. 1, 3, 4, 7-11), for example, to facilitate vehicle service simulation using at least one instance of a simulated autonomous vehicle. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 502, method 500 includes obtaining data indicative of at least one instance of a simulated autonomous vehicle. In some examples, a vehicle service test system provides one or more interfaces that enable users (e.g., software developers for autonomous vehicle computing systems) to design and test vehicle services using simulated autonomous vehicles. Data defining a simulated autonomous vehicle instance can be obtained in response to input received from a user through the one or more user interfaces. The test system may obtain from a remote computing system a request for an autonomous vehicle simulation in some examples.

The vehicle service test system can obtain data defining at least one instance of a simulated autonomous vehicle. In some examples, a user such as a developer may define the at least one instance of the simulated autonomous vehicle using one or more interfaces provided by the vehicle service test system. In this manner, a user may provision a new simulated autonomous vehicle to be evaluated in accordance with one or more vehicle services. The data defining the at least one instance of the simulated autonomous vehicle may include data defining one or more capabilities of the autonomous vehicle, a state of the autonomous vehicle, etc.

At 504, method 500 includes obtaining data indicative of one or more parameters for simulating an autonomous vehicle service using the at least one instance of the simulated autonomous vehicle. Similar to the data indicative of the instance of the simulated AV, data indicative of one or more parameters for at least one vehicle service simulation can be obtained, for example, in response to input received from a user through the one or more user interfaces. The vehicle service test system can obtain data indicative of one or more parameters for at least one vehicle service simulation in example embodiments. The parameters for a vehicle service simulation may include parameters that define a vehicle service-flow. For example, data defining a vehicle service-flow may define a dispatch of a vehicle service to an instance of a simulated autonomous vehicle. Data defining the vehicle service-flow may also include data instructing the instance of the simulated autonomous vehicle to accept or reject the service request. The data may additionally include data indicative of service-flow updates and/or location updates. The data may indicate a route from a pick-up location to a drop-off location in example embodiments. A software developer can provide control commands and/or predefined simulation scenarios for an instance of the autonomous vehicle in some examples. A predefined simulation scenario can be provided as a scenario object to at least one instance of the simulated autonomous vehicle in example embodiments.

In some examples, the vehicle test system can obtain data for controlling a state of the instance of a simulated autonomous vehicle. The data for controlling the state of the simulated autonomous vehicle instance may enable a user to define or control the autonomous vehicle state. The autonomous vehicle state may be controlled directly, such as by issuing commands to the instance of the autonomous vehicle, or may be controlled using one or more predefined simulation scenarios. In various examples, data indicative of a vehicle state may indicate a position of the simulated autonomous vehicle, credentials for the autonomous vehicle, an autonomous vehicle status, or a client at the vehicle service test system that is associated with the instance of the simulated autonomous vehicle.

At 506, method 500 includes initiating at least one autonomous vehicle service simulation using the at least one instance of the simulated autonomous vehicle and the one or more parameters. The test system can initiate one or more vehicle service simulations using the one or more parameters and the simulated autonomous vehicle. In this manner, users can define and debug vehicle service-flows within a single set of user interfaces. A user can manually control a vehicle service-flow in some examples by controlling an autonomous vehicle state. In other examples, a user can automate control of the vehicle service-flow using one or more predefined simulation scenarios. The vehicle test system can perform one or more autonomous vehicle (AV) service simulations using an instance of the simulated autonomous vehicle. An AV service simulation can include parameters that define a step (also referred to as a tick) duration, a vehicle movement strategy (e.g., no operation, move to pickup and drop-off locations, move using a constant speed and straight line, or move using a constant number of steps), vehicle callbacks (e.g., always reject, always accept, no operation), and/or a maximum number of steps. A vehicle service simulation can result in a termination condition in response to a vehicle entering a terminal state (e.g., vehicle is offline), a vehicle performing a terminating transition (e.g., door open), a termination command being executed, or a maximum number of steps being reached.

At 508, method 500 includes generating data indicative of the at least one autonomous vehicle trip simulation using the at least one instance of the simulated autonomous vehicle and the one or more parameters. The test system may determine and store metrics for a simulated autonomous vehicle session in some examples. Example metrics may include for interface calls (e.g., programmed in an SDK): a number of succeeded method attempts; a number of failed method attempts; a latency of attempts; and a number of bytes in and out. Example metrics for the session may further include a vehicle state heartbeat; a state using a I/O gauge; an exceptions or equivalent (e.g., exception tag); all exceptions; and vehicle uptime.

The test system may determine and store metrics for a simulated autonomous vehicle service in some examples. Example metrics may include: CPU; memory; GC; number of containers; number of threads; uptime; and a number of sessions. Metrics for interface calls (e.g., remote procedure calls) may include: a number of succeeded method attempts; a number of failed method attempts; a latency of attempts; and a number of bytes in and out.

In some examples, the test system may determine and store success metrics including, by way of example: a time to set up a simulated AV instance and dispatch a trip from the service-flow simulator; a time to provision a simulated AV instance locally or in the platform (e.g., cloud-based) and to go online; a number active platform simulated AVs and sessions per week; a number of platform test services per week; a number of finished scenario jobs per week; a number of scenarios; and a number of other projects using the simulated AV instances.

By providing a simulated testing environment that provides developer control over vehicle service-flows as well as autonomous vehicle definition, a quick and efficient technique for designing and evaluating vehicle service-flows can be provided. Such a technique may avoid computational waste that may be incurred by systems that attempt to test vehicle service-flows and/or autonomous vehicles outside of a simulated environment. In such systems, small changes to a vehicle service flow and/or an autonomous vehicle may require significant changes to test systems. By contrast, the disclosed technology enables vehicle services and autonomous vehicle designs to be quickly and efficiently tested.

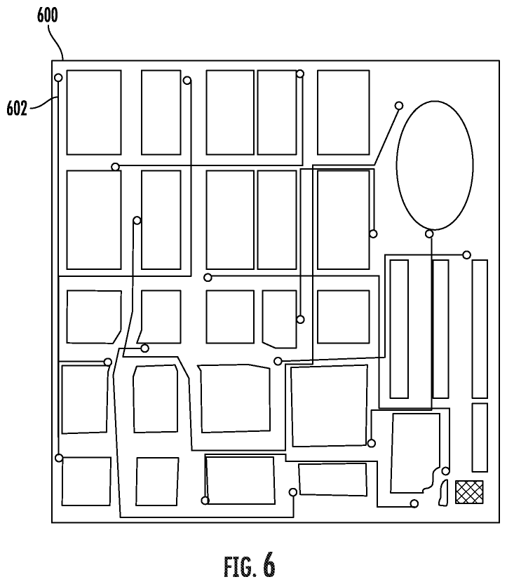

FIG. 6 depicts an example operational domain 600 in which an autonomous vehicle may operate to provide vehicle services. The identified operational domain 600 can include, for example, a geographic area in which a service entity may utilize autonomous vehicles to provide vehicle services. For instance, this may include a city in which transportation services are provided by autonomous vehicles.

A computing system (e.g., associated with a service entity) can simulate autonomous vehicle services using a simulated autonomous vehicle within a geographic area corresponding to an operational domain 600. A computing system can simulate autonomous vehicles and operations in an operational domain based on the capabilities of an autonomous within the operational domain.

The computing system can also obtain data indicative of the potential travel routes 602 within the operational domain (e.g., various travel routes for transporting users). To help evaluate an instance of a simulated autonomous vehicle, the computing system can obtain data associated with a plurality of potential travel routes 602 within the operational domain in some examples. Such data can be obtained via a local memory and/or a remote memory that stores travel route data associated with the operational domain. Each of the plurality of potential travel routes can start and end within the operational domain. For instance, in some implementations, the plurality of travel routes can be based at least in part on the travel routes within the operational domain that can be traversed by autonomous vehicles.

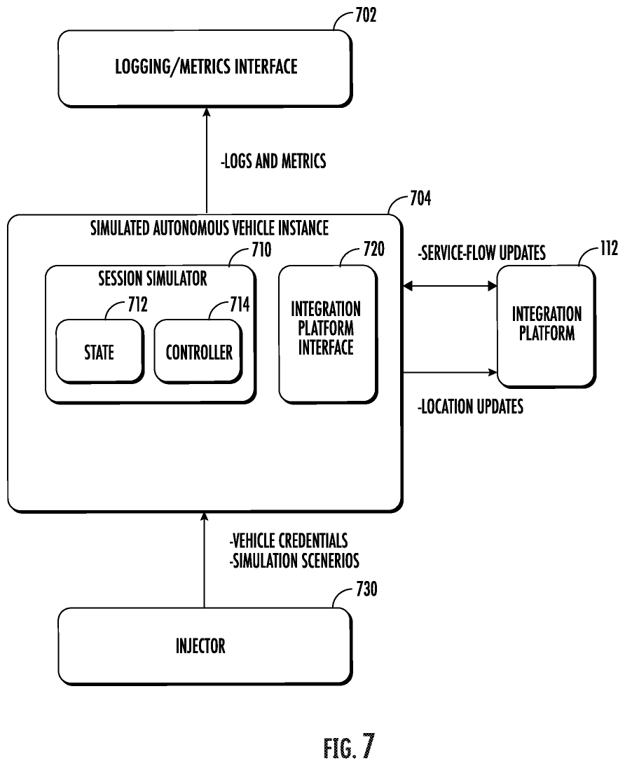

FIG. 7 depicts an example computing system including a simulated autonomous vehicle instance 704 according to example embodiments of the present disclosure. Simulated autonomous vehicle instance 704 can be a platform autonomous vehicle instance 264 or a local autonomous vehicle instance 274 in various examples. In accordance with example aspects, a vehicle simulation service may include a session which is a stable, long-running task used to simulate a vehicle service-flow of an autonomous vehicle. In such examples, one instance of the vehicle simulation service session can be used to model one instance of the autonomous vehicle. For example, there can be one instance of the same simulated autonomous vehicle session within the autonomous vehicle service platform at a given time. In this manner, two sessions of an autonomous vehicle instance can be the same if they start using the same simulated autonomous vehicle identifier.

A simulated autonomous vehicle instance 704 can include a session simulator 710 and an integration platform interface 720 in some examples. The integration platform interface 720 can be a software development kit in some embodiments. The session simulator 710 can include a state 712 component and a controller 714. An injector 730 can provide vehicle credentials and simulation scenarios to the simulated autonomous vehicle instance 704 in example embodiments. The state 712 of a simulated autonomous vehicle instance session can be compact and simple. For example, the state of an AV instance session can include attributes such as a position of the autonomous vehicle, credentials for the autonomous vehicle, a status of the autonomous vehicle, and/or an identification of the vehicle simulation service client interface at the service-flow simulator. In some examples, the state can be persisted in an external and/or internal system. This may allow restoring sessions after service upgrades and restarts. The session controller 714 can be used to access and modify the session state 712. The session simulator 710 can provide callbacks to the integration platform interface 720 and can define behavior of the simulated autonomous vehicle by connecting the integration platform interface 720 with the session state. For example, the session simulator 710 can define callbacks giving vehicle position from the session state 712 to the integration platform interface 720. The session simulator 710 can also be used to execute simulation scenarios. Locally, a developer can link a vehicle simulation service to a custom location of an integration platform interface repository for debugging. With the vehicle simulation services implemented at the platform, a mechanism and remote procedure call can be exposed for setting a custom version of the integration platform interface for each session individually to provide improved flexibility.

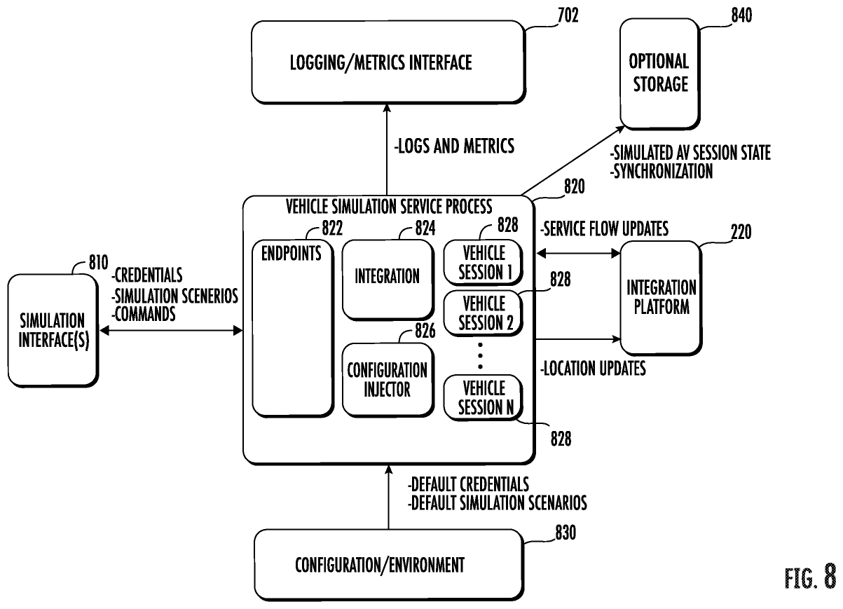

FIG. 8 depicts an example computing system including a vehicle simulation service process 820 according to example embodiments of the present disclosure. In some examples, a vehicle simulation service process 820 may communicate with the integration platform 220 and simulation interfaces 810 (e.g., service-flow simulator interface 310 and/or vehicle simulator interface 320). In some examples, interfaces 810 may be provided at one or more client computing devices. The vehicle simulation service process 820 may include one or more endpoints 822 (e.g., remote procedure call (RPC) end points) to facilitate communication with simulation interfaces (e.g., client computing devices using CLI and/or RPC). For example, the vehicle simulation service process 820 can route remote procedure calls to simulated autonomous vehicle session controllers using client RPC credentials. Optionally, the vehicle simulation service process can include an interface tool which can simplify calling RPC endpoints from a terminal. The one or more endpoints 822 may receive and/or transmit credentials, simulation scenarios, and/or control commands to and from the simulation interfaces. The vehicle simulation service process 820 may additionally include an integration component 824 and configuration injector 826. The vehicle simulation service process 820 may include one or more vehicle sessions 828. The vehicle simulation service process may receive one or more default credentials and/or default simulation scenarios from a configuration/environment 830. The vehicle simulation service process 820 may send and receive service-flow updates to and from the integration platform 220. Additionally, the vehicle simulation service process 820 may provide location updates of the simulated autonomous vehicle to the integration platform 220. Various logs and metrics associated with a vehicle simulation can be provided from the vehicle simulation service process to a logging/metrics interface 702. Optionally, the vehicle simulation service process can provide data indicative of a simulated autonomous vehicle session state and/or synchronization information to optional storage 840 (e.g., storage device or service). In some examples, a vehicle simulation service can optionally allow the use of an external storage service for persisting and restoring vehicle sessions. The external storage can also be used to implement synchronization for simulated autonomous vehicle sessions such as in a sharding mechanism.

In accordance with example embodiments, a simulated autonomous vehicle instance 704 may utilize one or more application programming interfaces (APIs). For example, a first call may allow provisioning of an autonomous vehicle. The first call may cause the generation of a self-signed certificate and the creation of a new instance of an autonomous vehicle. An error may be returned if there is already an existing instance of the vehicle created with the same universal identifier. A second call may cause deletion of a vehicle instance from the vehicle simulation service. An error can be returned of the vehicle does not exist or cannot be removed. A third call can cause retrieval of information about a given vehicle instance. A fourth call can return information about all vehicle instances provisioned within the vehicle simulation service.

In accordance with example embodiments, a session simulator 710 of a simulated autonomous vehicle instance may utilize one or more APIs. A first call for the session simulator may start a new simulated autonomous vehicle session for a given vehicle. A second call can stop a simulated autonomous vehicle session for a given vehicle. A third call can return the current state of an autonomous vehicle session. A fourth call can attempt to execute a go online function and update the status field of a vehicle state. A fifth call can attempt to execute a client go off-line function and update a status field of the vehicle state. A sixth call can update the pose field of the vehicle state. A seventh call can instruct the session simulator to accept a vehicle service request. An eighth call can instruct the session simulator to reject a vehicle service request. A ninth call can find a stored simulation scenario by universal identifier and execute it. A tenth call can execute a provided simulation scenario object.

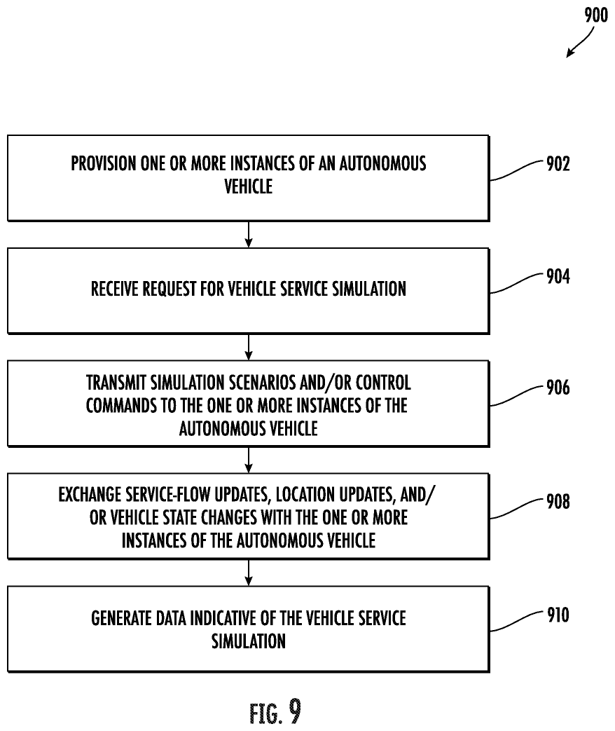

FIG. 9 depicts a flowchart illustrating an example method for initializing and performing an autonomous vehicle simulation according to example embodiments of the present disclosure. One or more portion(s) of the operations of method 900 can be implemented by one or more computing systems that include, for example, a vehicle computing system (e.g., vehicle computing system 112, etc.), an autonomous vehicle service platform 210, one or more portions of an operations computing system (e.g., operations computing system 104, etc.), one or more remote computing systems 106 (e.g., remote computing system 106, remote computing device 270, third-party computing device 280, etc.), computing system 1002, computing system 1102, vehicle service test system 200, and/or one or the like. Each respective portion of the method 900 can be performed by any (or any combination) of the computing device(s) of the respective computing system. Moreover, one or more portion(s) of the method 900 can be implemented as an algorithm on the hardware components of the device(s) described herein (e.g., as in FIGS. 1, 3, 4, 7-11), for example, to facilitate vehicle service simulation using at least one instance of a simulated autonomous vehicle. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, method 900 includes provisioning one more instances of a simulated autonomous vehicle. An autonomous vehicle instance can be provisioned at the autonomous vehicle service platform in some examples. Additionally and/or alternatively, an autonomous vehicle instance can be provisioned at a remote computing device operated by an autonomous vehicle service provider and/or a third-party entity such as a third-party entity operating autonomous vehicles for the autonomous vehicle service provider. In some examples, an autonomous vehicle instance can be provisioned via a vehicle simulator interface. For example, a user can provide input at a vehicle simulator interface to generate an autonomous vehicle instance which can be provisioned at a computing device local to the autonomous vehicle service platform or remote from the autonomous vehicle service platform.

At 904, method 900 includes receiving a request for a vehicle service simulation. In some examples, a request for a vehicle service simulation can be received at a service flow simulator of an autonomous vehicle service platform. The request can be received from a service flow simulator interface an example embodiments. The service flow simulator interface may include a command line interface or other interface in example embodiments.

At 906, method 900 includes transmitting one more simulation scenarios and/or control commands to the one or more instances of the autonomous vehicle. The one or more simulation scenarios and/or controller commands can be transmitted to an autonomous vehicle instance via a service flow simulator and/or integration platform in example embodiments.

In accordance with some examples, a developer can provide one or more simulation scenarios to simulate various types of vehicle service-flows with respect to an autonomous vehicle. A predefined simulation scenario can be used with respect to autonomous vehicles to allow a developer to evaluate numerous vehicle services to determine the resulting performance of different types of autonomous vehicles with respect to the vehicle services. Moreover, a developer can debug a vehicle service flow to identify any issues that may be associated with deployment of the vehicle

In accordance with some embodiments, a developer can provide control commands to simulate autonomous vehicle operations in association with the vehicle service. The control commands can allow developer to initialize and/or manipulate an autonomous vehicle state to evaluate the response of the simulated autonomous vehicle while performing a vehicle service. In this manner, the response characteristics of different autonomous vehicles can be evaluated with respect to different types of vehicle services to better understand and evaluate the resulting performance. In this manner, simulations can be implemented to test and evaluate each aspect of a vehicle service with respect to a particular autonomous vehicle type. Such a technique can allow successful integration of multiple third-party systems, such as various vendors of autonomous vehicles, within a single autonomous vehicle service platform. In this manner, a service entity can utilize autonomous vehicles from multiple vendors in a single system in both a resource and time-efficient manner while avoiding computational waste associated with some computing processes. For example, vehicle services provided by the vehicle service platform can be evaluated to demonstrate the performance of various autonomous vehicles while performing different vehicle services.

At 908, method 900 includes exchanging service flow updates, location updates, and/or vehicle state changes with the one or more instances of the autonomous vehicle. By way of example, service flow updates can be exchanged between autonomous vehicle instance and a service flow updater via the integration platform in some examples. Location updates can be exchanged utilizing a real-time interface between the integration platform in the service flow simulator in example embodiments. Vehicle state changes can be exchanged between the vehicle simulation service client in an autonomous vehicle instance in example embodiments.

At 910, method 900 includes generating data indicative of the vehicle service simulation. In accordance with some aspects of the disclosed technology, the test system may determine and store metrics for a simulated autonomous vehicle session, metrics for a simulated autonomous vehicle service, success metrics, etc. as earlier described.

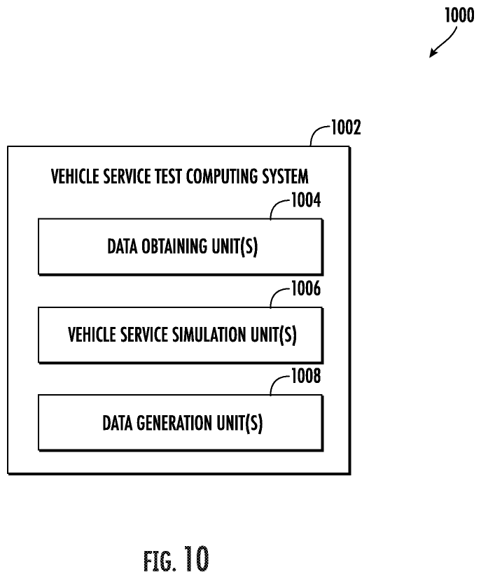

Various means can be configured to perform the methods and processes described herein. For example, FIG. 10 depicts a block diagram of an example computing environment 1000 that includes various means according to example embodiments of the present disclosure. For example, a vehicle service test computing system 1002 can include data obtaining unit(s) 1004, vehicle service simulation unit(s) 1006, data generation unit(s) 1008, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. The methods (e.g., method 500, method 900) and/or other operations described herein can be implemented as such algorithm(s). For instance, the means (data obtaining unit(s) 1004) can be configured to obtain data indicative of at least one instance of a simulated autonomous vehicle and/or data indicative of one or more parameters for at least one vehicle service simulation. (e.g., via an accessible memory). In some implementations, the means (e.g., data obtaining unit(s) 1004) can be configured to obtain data indicative of an instance of an autonomous vehicle by obtaining data that defines the at least one instance of the simulated autonomous vehicle. In some implementations, the means (e.g., data obtaining unit(s) 1004) can be configured to obtain from through a user interface data that is utilized to provision at least one instance of a simulated autonomous vehicle. In some implementations, the means (e.g., data obtaining unit(s) 1004) can be configured to obtain data indicative of order more predefined simulation scenarios. In some implementations, the means (e.g., data obtaining unit(s) 1004) can be configured to obtain data indicative of one or more control commands for controlling an instance of an autonomous vehicle. In some implementations, the means (e.g., data obtaining unit(s) 1004) can be configured to receive data indicative of at least one state associated with the simulated autonomous vehicle. A data obtaining unit is one example of a means for obtaining such data as described herein.

The means (e.g., vehicle service simulation unit(s)) 1006) can be configured to initiate at least one vehicle service simulation using at least one instance of a simulated autonomous vehicle and one or more parameters for the vehicle service simulation. For example, the means (e.g., vehicle service simulation unit(s)) 1006) can be configured to transmit to the at least one instance of the simulated autonomous vehicle of vehicle service update based at least in part of the more parameters. The means (e.g., vehicle service simulation unit(s)) 1006) can be configured to receive from the at least one instance of the simulated autonomous vehicle or more location updates based at least in part of vehicle service update. In some examples, the means (e.g., vehicle service simulation unit(s)) 1006) can be configured to implement vehicle simulation session have a state. The state can include one or more attributes. The attributes can include a position of the simulated autonomous vehicle, a status of the simulated autonomous vehicle, credentials associated with of the simulated autonomous vehicle, and/or other information. A vehicle service simulation unit is one example of a means for initiating a vehicle service simulation using at least one instance of a simulated autonomous vehicle and one or more parameters for the at least one vehicle service simulation.

The means (e.g., data generation unit(s) 1008) can be configured to generate data indicative of the at least one autonomous vehicle service simulation. The means (e.g., data generation unit(s) 1008) can be configured to generate the data based at least in part on the instance of the simulated autonomous vehicle and the one or more parameters obtained by the data obtaining means. The means (e.g., data generation unit(s) 1008) can be configured to generate simulated autonomous vehicle session state information and/or synchronization information. A data generation unit is one example of a means for generating data indicative of at least one autonomous vehicle service simulation.

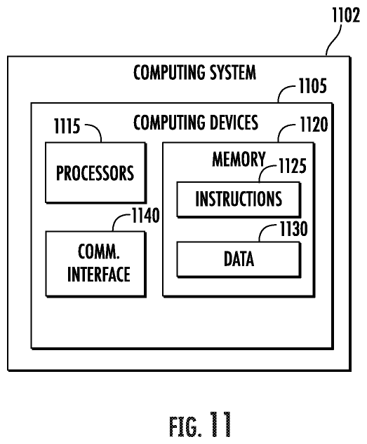

FIG. 11 depicts an example computing system 1102 according to example embodiments of the present disclosure. The computing system 1102 illustrated in FIG. 11 is provided as an example only. The components, systems, connections, and/or other aspects illustrated in FIG. 11 are optional and are provided as examples of what is possible, but not required, to implement the present disclosure. The computing system 1102 can represent/correspond to the vehicle computing system, operations computing system, vehicle service testing system, and/or other computing systems, devices, units, etc. described herein. The computing system 1102 can be communicatively coupled with a remote computing system over one or more network(s).

The computing device(s) 1105 of the computing system 1110 can include processor(s) 1115 and a memory 1120. The one or more processors 1115 can be any suitable processing device (e.g., a processor core, a microprocessor, an ASIC, a FPGA, a controller, a microcontroller, etc.) and can be one processor or a plurality of processors that are operatively connected. The memory 1120 can include one or more non-transitory computer-readable storage media, such as RAM, ROM, EEPROM, EPROM, one or more memory devices, flash memory devices, data registrar, etc., and combinations thereof.

The memory 1120 can store information that can be accessed by the one or more processors 1115. For instance, the memory 1120 (e.g., one or more non-transitory computer-readable storage mediums, memory devices) can include computer-readable instructions 1125 that can be executed by the one or more processors 1115. The instructions 1125 can be software written in any suitable programming language or can be implemented in hardware. Additionally, or alternatively, the instructions 1125 can be executed in logically and/or virtually separate threads on processor(s) 1115.

For example, the memory 1120 can store instructions 1125 that when executed by the one or more processors 1115 cause the one or more processors 1115 (the computing system 1102) to perform operations such as any of the operations and functions of the vehicle computing system (or for which it is configured), one or more of the operations and functions of the vehicle provider computing systems (or for which it is configured), one or more of the operations and functions of the operations computing systems described herein (or for which it is configured), one or more of the operations and functions of the vehicle service testing system (or for which it is configured) one or more operations and functions for simulating and evaluating autonomous vehicles, one or more portions of methods 500 or 900, and/or one or more of the other operations and functions of the computing systems described herein.

The memory 1120 can store data 1130 that can be obtained (e.g., acquired, received, retrieved, accessed, created, stored, etc.). The data 1130 can include, for instance, any of the data/information described herein such as, for example, data indicative of one or more capabilities of an autonomous vehicle, data indicative of operational domain(s), data indicative of potential travel routes, information associated with operational domain(s), data indicative of vehicle service dynamics, data indicative of levels of addressability, data indicative of prioritizations, data indicative of rankings, outputs, and/or other data/information. In some implementations, the computing device(s) 1105 can obtain data from one or more memories that are remote from the computing system 1102.

The computing device(s) 1105 can also include a communication interface 1140 used to communicate with one or more other system(s) of the computing system 1102 and/or a remote computing device that is remote from the computing system 1102. The communication interface 1140 can include any circuits, components, software, etc. for communicating via one or more networks. The communication interface 1140 can include, for example, one or more of a communications controller, receiver, transceiver, transmitter, port, conductors, software and/or hardware for communicating data.

The network(s) utilized by the computing system 1102 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) can be accomplished, for instance, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for testing autonomous vehicle services, comprising:
receiving, by a computing system comprising one or more computing devices from a remote computing system, a request for an autonomous vehicle service simulation;
obtaining, by the computing system, data indicative of at least one instance of a simulated autonomous vehicle;
obtaining, by the computing system, data indicative of one or more parameters for simulating an autonomous vehicle service using the at least one instance of the simulated autonomous vehicle;
initiating, by the computing system, an autonomous vehicle service simulation using the at least one instance of the simulated autonomous vehicle and the one or more parameters; and
generating, by the computing system, data indicative of the autonomous vehicle service simulation using the at least one instance of the simulated autonomous vehicle and the one or more parameters.

2. The computer-implemented method of claim 1, wherein obtaining, by the computing system, data indicative of at least one instance of the simulated autonomous vehicle comprises:
accessing the at least one instance of the simulated autonomous vehicle using at least one interface.

3. The computer-implemented method of claim 2, wherein:
the at least one interface includes an interface programmed in a software development kit.

4. The computer-implemented method of claim 1, further comprising:
transmitting, by the computing system to the at least one instance of the simulated autonomous vehicle, a vehicle service-flow update associated with the autonomous vehicle service simulation; and
receiving, by the computing system from the at least one instance of the simulated autonomous vehicle, one or more location updates based on at least in part on the vehicle service-flow update.

5. The computer-implemented method of claim 1, further comprising:
provisioning, by the computing system, the at least one instance of the simulated autonomous vehicle at one or more computing devices based at least in part on input received from a user through one or more interfaces.

6. The computer-implemented method of claim 1, further comprising:
obtaining, by the computing system, data for controlling a state of the at least one instance of the simulated autonomous vehicle.

7. The computer-implemented method of claim 6, wherein:
the data for controlling the state of the at least one instance of the simulated autonomous vehicle includes data indicative of one or more predefined simulation scenarios; and
the method further comprises controlling, by the computing system, the at least one instance of the simulated autonomous vehicle based on the one or more predefined simulation scenarios.

8. The computer-implemented method of claim 7, further comprising:
providing, by the computing system, each of the one or more predefined simulation scenarios as a respective scenario object to the at least one instance of the simulated autonomous vehicle.

9. The computer-implemented method of claim 6, wherein:
the data for controlling the state of the at least one instance of the simulated autonomous vehicle includes data indicative of an input from a user via a user interface to directly control the state of the simulated autonomous vehicle.

10. The computer-implemented method of claim 1, wherein obtaining, by the computing system, data indicative of one or more parameters for simulating the autonomous vehicle service using the at least one instance of the simulated autonomous vehicle comprises:
obtaining data indicative of one or more user-defined parameters for the at least one instance of the simulated autonomous vehicle.

11. The computer-implemented method of claim 1, wherein obtaining, by the computing system, data indicative of one or more parameters for simulating the autonomous vehicle service using the at least one instance of the simulated autonomous vehicle comprises:
receiving the data indicative of the one or more parameters at the at least one instance of the simulated autonomous vehicle via an application programming interface.

12. The computer-implemented method of claim 1, wherein obtaining, by the computing system, data indicative of one or more parameters for simulating the autonomous vehicle service using the at least one instance of the simulated autonomous vehicle comprises:
receiving an instruction at the at least one instance of the simulated autonomous vehicle to reject a vehicle service request.

13. The computer-implemented method of claim 1, wherein obtaining, by the computing system, data indicative of one or more parameters for simulating the autonomous vehicle service using the at least one instance of the simulated autonomous vehicle comprises:
receiving an instruction at the at least one instance of the simulated autonomous vehicle to accept a vehicle service request.

14. The computer-implemented method of claim 1, wherein generating, by the computing system, data indicative of the autonomous vehicle service simulation comprises:
implementing a vehicle simulation session having a session state, the session state including one or more attributes defining at least one of a position of the simulated autonomous vehicle or a status of the simulated autonomous vehicle.

15. The computer-implemented method of claim 1, further comprising:
receiving a vehicle service request; and
matching the vehicle service request to the at least one instance of the simulated autonomous vehicle.

16. The computer-implemented method of claim 1, further comprising:
providing, by the computing system, an interface for debugging the autonomous vehicle service simulation.

17. A computing system comprising:
one or more processors; and
one or more tangible, non-transitory, computer readable media that collectively store instructions that when executed by the one or more processors cause the computing system to perform operations comprising:
receiving from a remote computing system a request for an autonomous vehicle service simulation;
obtaining data indicative of at least one instance of a simulated autonomous vehicle;
obtaining data indicative of one or more parameters for simulating an autonomous vehicle service using the at least one instance of the simulated autonomous vehicle;
initiating the autonomous vehicle service simulation using the at least one instance of the simulated autonomous vehicle and the one or more parameters; and
generating data indicative of the autonomous vehicle service simulation using the at least one instance of the simulated autonomous vehicle and the one or more parameters.

18. The computing system of claim 17, wherein obtaining, by the computing system, data indicative of at least one instance of the simulated autonomous vehicle comprises:
accessing the at least one instance of the simulated autonomous vehicle using at least one interface.

19. The computing system of claim 17, wherein the operations further comprise:
provisioning the at least one instance of the simulated autonomous vehicle at one or more computing devices based at least in part on input received from a user through one or more interfaces.

20. One or more tangible, non-transitory, computer-readable media that collectively store instructions that, when executed by one or more processors, cause the one or more processors to perform operations, the operations comprising:
receiving from a remote computing system a request for an autonomous vehicle service simulation;
obtaining data indicative of at least one instance of a simulated autonomous vehicle;
obtaining data indicative of one or more parameters for simulating an autonomous vehicle service using the at least one instance of the simulated autonomous vehicle;
initiating the autonomous vehicle service simulation using the at least one instance of the simulated autonomous vehicle and the one or more parameters; and
generating data indicative of the autonomous vehicle service simulation using the at least one instance of the simulated autonomous vehicle and the one or more parameters.
